(19) United States
(12) Patent Application Publication
(10) Pub. No.: US 2023/0148651 A1
(43) Pub. Date: May 18, 2023

(54) BEVERAGE COMPOSITIONS COMPRISING A PRINTED IMAGE AND METHODS OF MAKING THE SAME

(71) Applicant: PepsiCo, Inc., Purchase, NY (US)

(72) Inventors: Gurmeet Singh BHUTANI, Gurgaon, Haryana (IN); Dewang PARIKH, New Canaan, CT (US)

(21) Appl. No.: 17/763,544

(22) PCT Filed: Oct. 21, 2021
(86) PCT No.: PCT/US2021/055994

§ 371 Date: Mar. 24, 2022

(30) Foreign Application Priority Data
Oct. 23, 2020 (IN) 202041046196

(51) Int. Cl. A23P 20/20; A23L 2/54; A23P 30/40; A23L 2/38; A23L 2/66; A23G 9/04; A23G 9/48; A23L 2/56

(52) U.S. Cl. CPC A23P 20/20; A23G 9/045; A23G 9/48; A23L 2/38; A23L 2/54; A23L 2/56; A23L 2/66; A23P 30/40; A23P 2020/253

(57) ABSTRACT

The present disclosure provides beverages displaying an edible printed image and a method of preparing such beverages.

### BACKGROUND

Personalized beverages displaying an image of interest printed on top of the beverage are gaining popularity among younger consumers. Typically, these personalized beverages comprise a dairy-based foam as a printing substrate. But dairy-based foams are not suitable for all types of beverages. For example, dairy-based foams react with carbonated beverages and tend to collapse quickly, making them unsuitable for use with carbonated beverages. Furthermore, dairy-based foams have a high fat content and may not desirable for use in combination with a carbonated beverage due to dietetic concerns.

### SUMMARY

The present disclosure provides a beverage composition comprising: a beverage; a foamed topping composition in fluid communication with a topmost surface of the carbonated beverage, the foamed topping composition comprising a vegetable fat and water; and a printed image on a topmost surface of the foamed topping composition; wherein the foamed topping composition is substantially free of dairy.

In some embodiments the foamed topping composition further comprises: an emulsifier; a stabilizer; optionally a protein; optionally a sweetener; and optionally a flavoring agent.

In some embodiments the vegetable fat is partially or wholly hydrogenated vegetable oil, or a combination thereof.

In some embodiments the emulsifier is selected from the group consisting of mono-, di-, or triglycerides of fatty acids, lactic acid esters of mono- and diglycerides, diacetyl tartaric acid esters of mono- and diglycerides, polyglycerol esters of fatty acid, sodium stearolyl lactylate, hexaglyceryl distearate, lecithin, hydroxylated lecithin, a polyoxyethylene ether of fatty esters of polyhydric alcohols, sucrose esters, and combinations thereof.

In certain embodiments the stabilizer is selected from the group consisting of microcrystalline cellulose, hydroxypropyl cellulose, hydroxypropyl methylcellulose, hydroxyethyl cellulose, carboxymethyl cellulose, starch, methylcellulose, ethylcellulose, carboxymethyl starch, hydrophobically modified starch, guar, pectin, pectinate, pectate, xanthan, carrageenan, agar, gellan, scleroglucan, betaglucan, alginate and alginic acid, propylene glycol-alginate, gum arabic, gum tragacanth, konjac gum, chitin, chitosan, locust bean gum, and combinations thereof.

In certain embodiments the protein is selected from the group consisting of whey, whey hydrolysate, whey concentrate, lactalbumin, β-lactoglobulin, bovine serum albumin, acid casein, casein, casein hydrolysate, caseinates, salts of caseinates, soy protein, rice protein, pea protein, wheat protein, corn protein, vegetable protein, wheat gluten, and combinations thereof.

In a particular embodiment the foamed topping composition comprises: about 25% vegetable fat; about 0.6% stabilizer; about 1% emulsifier; about 0.8% sodium caseinate; about 10% sucrose; and about 1% sorbitol.

In some embodiments the printed image comprises one or more edible inks.

The present disclosure further provides a method of making the beverage composition described herein, the method comprising the steps of: applying the foamed topping composition to the topmost surface of the beverage; and printing an image on the topmost surface of the foamed topping composition; wherein the foamed topping composition comprises a vegetable fat and water and wherein the foamed topping composition is substantially free of dairy.

In certain embodiments, the beverage is a carbonated beverage.

In certain embodiments, the foamed topping composition further comprises an emulsifier; a stabilizer; an optional protein; an optional sweetener; and an optional flavoring agent.

In certain embodiments, the vegetable fat is partially or wholly hydrogenated vegetable oil or a combination thereof.

In certain embodiments, the emulsifier is selected from the group consisting of mono-, di-, or triglycerides of fatty acids, lactic acid esters of mono- and diglycerides, diacetyl tartaric acid esters of mono- and diglycerides, polyglycerol esters of fatty acid, sodium stearolyl lactylate, hexaglyceryl distearate, lecithin, hydroxylated lecithin, a polyoxyethylene ether of fatty esters of polyhydric alcohols (i.e., a polysorbate, such as polysorbate 80), sucrose esters, and combinations thereof.

In certain embodiments, the stabilizer is selected from the group consisting of microcrystalline cellulose, hydroxypropyl cellulose, hydroxypropyl methylcellulose, hydroxyethyl cellulose, carboxymethyl cellulose, starch, methylcellulose, ethylcellulose, carboxymethyl starch, hydrophobically modified starch, guar, pectin, pectinate, pectate, xanthan, carrageenan, agar, gellan, scleroglucan, betaglucan, alginate and alginic acid, propylene glycol-alginate, gum arabic, gum tragacanth, konjac gum, chitin, chitosan, locust bean gum, and combinations thereof.

In certain embodiments, the protein is selected from the group consisting of whey, whey hydrolysate, whey concentrate, lactalbumin, β-lactoglobulin, bovine serum albumin, acid casein, casein, casein hydrolysate, caseinates, salts of caseinates, soy protein, rice protein, pea protein, wheat protein, corn protein, vegetable protein, wheat gluten, and combinations thereof.

In certain embodiments, the foamed topping composition comprises about 25% vegetable fat; about 0.6% stabilizer; about 1% emulsifier; about 0.8% sodium caseinate; about 10% sucrose; and about 1% sorbitol.

In certain embodiments, the printed image comprises one or more edible inks.

In a further aspect, the present disclosure also provides a slush beverage having a topmost surface comprising a frozen ice-crystal matrix; and a printed image on the topmost surface of the frozen ice-crystal matrix;

In certain embodiments, the slush beverage is carbonated or non-carbonated.

In certain embodiments, the slush beverage is carbonated.

In some other embodiments, the slush beverage is non-carbonated.

The present disclosure also provides a method of making the beverage composition comprising: a slush beverage having a topmost surface comprising a frozen ice-crystal matrix; and a printed image on the topmost surface of the frozen ice-crystal matrix, the method comprising printing an image on the topmost surface of the beverage using an inkjet printer with edible ink.

In certain embodiments, the edible ink further comprises a flavor

The present disclosure also provides a beverage composition comprising: a beverage; and an edible substrate comprising one or more pre-printed images on a surface of the substrate; wherein the edible substrate has a density sufficiently lower than the beverage such that at least one surface of the edible substrate is above a surface of the beverage and visible to someone drinking the beverage.

In certain embodiments the edible substrate is selected from the group consisting of a marshmallow, a cookie, a chocolate, a candy, a waffle, and a granola bar.

In other embodiments the edible substrate is a circular ice disk or ice wafer.

### DETAILED DESCRIPTION

Personalized beverages displaying one or more printed images are becoming increasingly popular and are especially appealing to younger consumers. Dairy-based foams have been used as a substrate to create personalized printed beverages. While dairy-based foams, such as traditional whipped cream, provides a pleasant organoleptic experience, they are not suitable substrates due to their reactivity with certain types of beverages. Carbonated beverages, for example, react with dairy-based foams, such as whipped cream, and cause the foam to collapse into the beverage very quickly after the foam has been applied to the topmost surface of the carbonated beverage. As a result, even if the dairy-based foam persists long enough to support a printed image, which is often not the case, dairy-based foam does not maintain its integrity for a sufficient period of time for a consumer to appreciate the product during consumption.

It has now, been surprisingly found that toppings that are substantially free of dairy can be suitable substrates for printing durable images to prepare personalized carbonated beverages. It has also been unexpectedly found that images can be directly printed on a frozen ice-crystal matrix at the top-most surface of a carbonated or non-carbonated slush beverage.

### Definitions

Various examples and embodiments of the beverage compositions disclosed herein are possible and will be apparent to a person of ordinary skill in the art, given the benefit of this disclosure. Accordingly, reference to “some embodiments,” “certain embodiments,” “certain exemplary embodiments” and similar phrases refer to certain non-limiting examples.

Unless otherwise indicated or unless otherwise clear from the context in which it is described, alternative and optional elements or features in any of the disclosed embodiments and examples are interchangeable with each other. That is, an element described in one embodiment or example should be understood to be interchangeable or substitutable for one or more corresponding but different elements in another described example or embodiment and, likewise, an optional feature of one embodiment or example may optionally also be used in other embodiments and examples. More generally, the elements and features of any disclosed example or embodiment should be understood to be disclosed generally for use with other aspects and other examples and embodiments. A reference to a component or ingredient being operative or configured to perform one or more specified functions, tasks and/or operations or the like, is intended to mean that it can perform such function(s), task(s), and/or operation(s) in at least certain embodiments, and may well be able to perform also one or more other functions, tasks, and/or operations.

The articles “a,” “an,” and “the” are used herein to refer to one or to more than one (i.e., to at least one) of the grammatical object of the article. By way of example, “an element” means one element or more than one element.

The word “comprising” is used in a manner consistent with its open-ended meaning, that is, to mean that a given product or process can optionally also have additional features or elements beyond those expressly described.

As used herein, the term “about” means ±10% of the noted value. By way of example only, a composition comprising “about 30 weight percent” of a compound could include from 27 weight percent of the compound up to and including 33 weight percent of the compound.

As used herein the term “substantially free of dairy” refers to a composition that contains not more than 20 weight percent amount of milk derived fats or lactose. These compositions may contain caseinates.

As used herein the term “substantially free of egg-white or egg-albumin” refers to a composition that contains not more than 20 weight percent amount of egg-white or egg albumin.

### Beverages

The present disclosure provides beverages suitable for preparing a beverage composition comprising a printed image. In certain embodiments, the beverage can be a carbonated or non-carbonated soft drink, a fountain beverage, a frozen ready-to-drink slush beverage, a coffee, a tea or other brewed beverage, a dairy beverage, a flavored water, an enhanced water, a juice such as a zero- or low-calorie fruit juice (including diluted and ready to drink concentrated juices), a fruit juice-flavored drink, a sport drink, a smoothie, or a functionally enhanced beverage such as a caffeinated energy drink.

In some embodiments, the beverage can be a carbonated soft drink, and in particular embodiments, the beverage can be a cola-flavored carbonated beverage, characteristically containing, amongst other things, water, sweetener, kola nut extract and/or other flavorings, caramel coloring, phosphoric acid, optionally caffeine, and optionally other ingredients. Additional and alternative suitable ingredients will be recognized by those skilled in the art given the benefit of this disclosure and the ubiquity of carbonated cola-flavored beverages in the art.

In embodiments where the beverage is a carbonated soft drink, a substrate, such as a foamed topping composition in fluid communication with a topmost surface of the carbonated beverage, can be used in order to provide a suitable surface for printing. Suitable examples of foamed topping compositions, which are discussed below, typically comprise a vegetable fat and water and are not reactive with the carbonated beverage. Accordingly, these foamed topping compositions provide a stable surface for printing.

In other embodiments, the beverage can be a slush beverage. Slush beverages can be either carbonated or non-carbonated partially frozen drinks. Exemplary slush beverages are disclosed, for example, in U.S. Pat. No. 7,579,032 and U.S. Pat. No. 3,826,829, the entireties of which are hereby incorporated by reference.

Unlike typical carbonated beverages, which are ordinarily cooled with ice cubes, slush beverages do not require the addition of ice and do not require a foamed topping composition in order to provide a stable substrate for printing. Instead, ice crystals present at the top most surface of the beverage can be used as the printing substrate so that an image can be effectively printed directly on the beverage itself. Ice crystals can be formed through appropriate cooling means and can be present in the beverage at the time it is produced, or crystallization can be induced via means known in the art.

Although slush beverages do not require a foamed topping composition, in certain embodiments, the beverage composition described herein can comprise a slush beverage, a foamed topping composition in fluid communication with a topmost surface of the slush beverage, and an image printed on the foamed topping composition.

### Foamed Topping Compositions

Many types of foamed topping compositions can be used in the beverage compositions described herein. In one embodiment, the foamed topping composition can comprise a vegetable fat and water. Because it is desirable for the foamed topping composition to be non-reactive with the beverage in the beverage composition, typically, the foamed topping composition is substantially free of dairy. In a further embodiment, the topping composition is substantially free of egg-white or egg-albumin.

Suitable vegetable fats for use in the foamed topping composition can include, but are not limited to, partially or wholly hydrogenated vegetable oils and mixtures thereof. Suitable vegetable oils can include, but are not limited to, coconut oil, soybean oil, cottonseed oil, palm oil, safflower oil, corn oil, sunflower oil, canola oil, and blends thereof. In some embodiments, the vegetable fat can be a hydrogenated palm kernel oil that is characterized by a trans-fatty acid content of less than 2%. In other embodiments, the vegetable oil can be hydrogenated soybean oil.

In some embodiments, the topping composition can further comprise an emulsifier, a stabilizer, optionally a protein, optionally a sweetener, and optionally a flavoring agent.

Suitable emulsifiers for use in the foamed topping composition can include, but are not limited to, mono-, di-, or triglycerides of fatty acids, lactic acid esters of mono-and diglycerides, diacetyl tartaric acid esters of mono- and diglycerides, polyglycerol esters of fatty acid, sodium stearolyl lactylate, hexaglyceryl distearate, lecithin, hydroxylated lecithin, a polyoxyethylene ether of fatty esters of polyhydric alcohols (i.e., a polysorbate, such as polysorbate 80), sucrose esters, and combinations thereof. In some embodiments, the emulsifier can be a blend of polysorbate 80 and sodium stearolyl lactylate.

Suitable stabilizers for use in the foamed topping composition can include, but are not limited to, microcrystalline cellulose, hydroxypropyl cellulose, hydroxypropyl methylcellulose, hydroxyethyl cellulose, carboxymethyl cellulose, starch, methylcellulose, ethylcellulose, carboxymethyl starch, hydrophobically modified starch, guar, pectin, pectinate, pectate, xanthan, carrageenan, agar, gellan, scleroglucan, betaglucan, alginate and alginic acid, propylene glycol-alginate, gum arabic, gum tragacanth, konjac gum, chitin, chitosan, locust bean gum, and combinations thereof. In some embodiments, the stabilizer can be a combination of microcrystalline cellulose and carrageenan.

Suitable proteins for use in the foamed topping composition can include, but are not limited to, whey, whey hydrolysate, whey concentrate, lactalbumin, β-lactoglobulin, bovine serum albumin, acid casein, casein, casein hydrolysate, caseinates, salts of caseinates, soy protein, rice protein, pea protein, wheat protein, corn protein, vegetable protein, wheat gluten, and combinations thereof. In some embodiments, the protein can be sodium caseinate.

Suitable sweeteners for use in foamed topping composition described herein can include, but are not limited to, non-caloric, low caloric, or caloric sweeteners or combinations thereof. In certain embodiments, caloric sweeteners include sugars such as sucrose, fructose, dextrose, lactose, maltose, high fructose corn syrup, as well as mixtures thereof. In other embodiments, non-caloric (or low caloric) sweeteners can be a high intensity sweetener, optionally combined with a bulking agent. High intensity sweeteners include, but are not limited to, the steviol glycosides, such as stevioside, steviolbioside, rebaudiosides including rebaudioside A, rebaudioside B, rebaudioside C, rebaudioside D, rebaudioside E, rebaudioside J, rebaudioside M, rebaudioside N, and dulcosides, including dulcoside A and dulcoside B. In particular embodiments, the sweetener can be a combination of one or more of sucrose, rebaudioside A, rebaudioside D, and rebaudioside M. Alternatively, and less preferentially, the high intensity sweetener can be aspartame, saccharin, cyclamate, or a combination thereof.

Suitable bulking agents, which can optionally be included in the foamed topping composition in combination with the high intensity sweeteners discussed above can include, but are not limited to d-psicose, erythritol, sorbitol, maltodextrin; dextrose-maltodextrin blends, hydroxypropylmethyl cellulose, carboxymethyl cellulose, polyvinylpyrrolidone, and mixtures thereof.

Flavors suitable for use in the foamed topping composition can include, but are not limited to, natural and synthetic fruit flavors, botanical flavors, other flavors, and mixtures thereof. As used here, the term “fruit flavor” refers generally to those flavors derived from the edible reproductive part of a seed plant. Included are both those wherein a sweet pulp is associated with the seed, e.g., banana, tomato, cranberry and the like, and those having a small, fleshy berry. The term berry also is used here to include aggregate fruits, i.e., not “true” berries, but fruit commonly accepted as such. Also included within the term “fruit flavor” are synthetically prepared flavors made to simulate fruit flavors derived from natural sources. Examples of suitable fruit or berry sources include whole berries or portions thereof, berry juice, berry juice concentrates, berry purees and blends thereof, dried berry powders, dried berry juice powders, and the like.

Exemplary fruit flavors include, but are not limited to, the citrus flavors, e.g., orange, lemon, lime grapefruit, tangerine, mandarin orange, tangelo, and pomelo, and such flavors as apple, grape, cherry, and pineapple flavors and the like, and mixtures thereof. In certain embodiments the foamed topping composition can comprise a fruit flavor component, e.g., a juice concentrate or juice.

As used here, the term “botanical flavor” refers to flavors derived from parts of a plant other than the fruit. As such, botanical flavors may include those flavors derived from essential oils and extracts of nuts, bark, roots and leaves. Also included within the term “botanical flavor” are synthetically prepared flavors made to simulate botanical flavors derived from natural sources. Examples of botanical flavors include cola flavors, tea flavors, and the like, and mixtures thereof. The foamed topping composition can further comprise a blend of several of the above-mentioned flavors.

In certain embodiments the foamed topping composition can comprise a cola flavor or a tea flavor. The particular amount of the flavor useful for imparting flavor characteristics to the foamed topping composition will depend upon the flavor(s) selected, the flavor impression desired, and the compatibility of the flavor with the foamed topping composition. It is within the skill of the skilled artisan to select the proper amount of flavoring based on the desired flavor intensity and other factors.

The foamed topping composition described herein can also include other ingredients known to those skilled in the art including, but not limited to, edible colorants, vitamins, minerals, and the like. In the event a foamed topping composition comprises a colorant, the colorant should be chosen such that it is not reactive with the edible printer ink used for printing the image on the beverage composition and/or the beverage itself. The colorant should likewise be chosen so that it does not obscure or impact the quality of the image printed on the beverage. It is within the skill of the ordinarily skilled artisan armed with this disclosure to select an appropriate edible colorant for use in the foamed topping composition.

In certain embodiments, the beverage topping composition can comprise water, hydrogenated palm kernel oil, sodium stearolyl lactylate, polysorbate 60, carrageenan, microcrystalline cellulose, sodium caseinate, sucrose, and sorbitol.

In certain embodiments, the foamed topping composition can comprise about 25% vegetable oil.

In some embodiments, the foamed topping composition can comprise about 1% emulsifier.

In certain embodiments, the foamed topping composition can comprise about 0.7% stabilizer. In certain other embodiments, the foamed topping composition can comprise about 0.5% stabilizer. In still further embodiments, the foamed topping composition can comprise about 0.4% stabilizer.

In some embodiments, the foamed topping composition can comprise about 0.8% protein. Alternatively, and in other embodiments, the foamed topping composition can be completely or substantially free of protein.

In some embodiments, the foamed topping composition can comprise about 10% sweetener.

In some embodiments, the foamed topping composition can comprise, or can optionally comprise, about 1% bulking agent

In some embodiments, the foamed topping composition can have a contrasting color, texture and/or flavor to provide the consumer with a pleasant visual and/or organoleptic experience.

For example, and in typical embodiments, the beverage can be caramel in color, like a typical carbonated kola beverage, such as PEPSI®, and the foamed topping composition can be white. In other embodiments, however, the beverage can be any color, such as red, orange, yellow, green, blue, indigo, or violet, or any shade or combination of any of these colors and the foamed topping composition can be white, or any other known color capable of being reproduced and used in foamed topping compositions. In some embodiments, the beverage can be colorless, like SIERRA MIST®.

In some embodiments the beverage can be a carbonated cola beverage and the foamed topping composition can lack a flavoring or can be vanilla flavored. In other embodiments the beverage can be fruit flavored, such as orange flavored and the foamed topping composition can be flavorless, can be vanilla flavored, or can fruit or botanical flavored. Suitable fruit and botanical flavors include those previously disclosed herein.

In some embodiments, the thickness of the foamed topping composition can range from about 10 mm to about 70 mm, such as from about 20 mm to about 70 mm, from about 30 mm to about 70 mm, from about 40 mm to about 70 mm, from about 50 mm to about 70 mm, or from about 60 mm to about 70 mm. In certain embodiments, the thickness of the foamed topping composition can range from about 30 mm to about 60 mm, from about 30 mm to about 60 mm, from about 40 mm to about 60 mm, or from about 50 mm to about 60 mm. In other embodiments, the thickness of the foamed topping composition can range from about 40 mm to about 50 mm. In other embodiments, the foamed topping composition can be 45 mm thick. Surprisingly, when the foamed topping composition has a thickness below 10 mm, it is not stable and cannot provide a surface suitable for printing.

### Methods for Preparing Beverage Compositions Comprising a Printed Image

In typical embodiments, the method for preparing a beverage composition comprising a printed image can comprise: applying a foamed topping composition to a topmost surface of a beverage, typically while the beverage is contained within a container, and printing an image of interest on a topmost surface of the foamed topping composition.

In some embodiments, the foamed topping composition has a topmost surface that is suitable for receiving a printed image immediately after application to the beverage’s topmost surface. In more typical embodiments, however, a smoothing step can be included in order provide a suitable surface for receiving a printed image. For example, and in some embodiments, the topmost surface of the foamed topping composition can be smoothed manually using a spatula or other suitable implement having a flat edge to provide a suitably smooth surface for printing. In other embodiments, the smoothing can be accomplished via a mechanical means, such as a mechanical arm comprising a suitably flat edge for leveling out domes, ridges, and/or other surface imperfections.

In some embodiments, the foamed topping composition can be applied at thickness ranging from about 20 mm to about 70 mm. In certain embodiments, the foamed topping composition can be applied at thickness ranging from about 10 mm to about 70 mm, such as from about 20 mm to about 70 mm, from about 30 mm to about 70 mm, from about 40 mm to about 70 mm, from about 50 mm to about 70 mm, or from about 60 mm to about 70 mm. In certain embodiments, the foamed topping composition can be applied at thickness ranging from about 30 mm to about 60 mm, from about 30 mm to about 60 mm, from about 40 mm to about 60 mm, or from about 50 mm to about 60 mm. In other embodiments, the foamed topping composition can be applied at thickness ranging from about 40 mm to about 50 mm. In other embodiments, the foamed topping composition can be applied at thickness of about 45 mm.

Once the foamed topping composition has been applied, smoothed and, optionally, reduced to a desired thickness, an image can be printed onto the topmost surface of the foamed topping composition using a suitable printer. In certain embodiments, the printer can be an automated inkjet printer such as commercially available beverage printer available from Kopybake, in Noida, India.

Because the beverage is edible, edible inks are used to print on the foamed topping composition. In certain embodiments, the edible ink can comprise, in addition to one or more food-grade colorants, a flavor. In certain embodiments, the flavor can be a botanical flavor, such as a coal flavor or a tea flavor. In other embodiments, the flavor can be a fruit flavor, such as any of those disclosed herein. In other embodiments, the edible inks can be flavorless.

While the foamed topping composition can be applied to any beverage (carbonated, non-carbonated, frozen, liquid, etc.), in certain embodiments, it is not necessary to use a foamed topping composition. For example, in embodiments where the beverage is a slush beverage, the method for preparing a beverage composition comprising a printed image can comprise printing an image of interest directly upon a frozen ice-crystal matrix at the top-most surface of the slush beverage. As discussed elsewhere herein, the image printed onto the ice-crystal matrix can be printed with beverage printer available from Kopybake, in Noida, India. And in general, any ink suitable for printing on the foamed topping composition will also be suitable for printing on the ice-crystal matrix.

In a further embodiment, crushed or shaved ice can be added to the surface of a beverage and an image can be printed on to the surface of the ice. While crushed or shaved ice is typically added to a liquid beverage, such as a carbonated cola beverage, the crushed or shaved ice can be added to a slush beverage, a non-carbonated beverage, or any beverage where a surface suitable for printing is desired.

In some embodiments, edible substrates with pre-printed images can be added to a beverage instead of printing on a foamed topping composition or on an ice-crystal matrix. In some embodiments, for example, a marshmallow comprising a printed image can be can be added to the beverage. In other embodiments, a circular ice disk or non-circular wafer (i.e. an ice wafer having any suitable shape other than a circle) having a pre-printed image on its surface can be applied to the top most surface of the beverage. Other edible substrates comprising a pre-printed image that can be added to a beverage include, but are not limited to, cookies, chocolates, candies, waffles, granola bars, and the like.

In some embodiments the image printed on the top-most surface of the foamed topping composition or on the ice-crystal matrix can be a two-dimensional image, a three-dimensional image, an outline, a gray-scaled image, a multi-colored image, a logo, a photographic image, written text, a pattern, a comic, a slogan, numbers, or any combination thereof.

Any limits regarding the type of image that can be printed will be solely attributable to limits of the printer used to apply the printed image. For example, limits to the resolution of the image will be controlled by the printer. That said, images having a resolution of 600 DPI x 600 DPI, are typical.

### Stability

In certain embodiments, the foamed topping composition can retain at least about 50% to about 90% of its height after about five minutes when the beverage has a temperature ranging from about -10° C. to about 21° C. In some embodiments, the foamed topping composition can retain about 65% of its height after about five minutes when the beverage has a temperature ranging from about -10° C. to about 21° C., about 75% of its height after about five minutes when the beverage has a temperature ranging from about -10° C. to about 21° C., about 80% of its height after about five minutes when the beverage has a temperature ranging from about -10° C. to about 21° C., or about 90% of its height after about five minutes when the beverage has a temperature ranging from about -10° C. to about 21° C. In some embodiments, the foam can retain about 40% to about 90% of its height after about ten minutes when the beverage has a temperature ranging from about -10° C. to about 21° C. Without wishing to be bound by a particular theory, it is believed that the temperature of the beverage affects stability of the foamed topping composition. Thus, the stabilities discussed above in terms of foamed topping composition height, may be meaningfully different if, for example, the beverage is warmer than about 21° C.

For beverages comprising a foamed topping composition, the image printed on the top-most surface of the foamed topping composition can remain stable and persist on the foamed topping composition for about 10 to about 60 minutes after printing. In other embodiments, the printed image can remain stable for about 10 minutes, about 15 minutes, about 20 minutes, about 25 minutes, about 30 minutes, about 35 minutes, about 40 minutes, about 45 minutes, about 50 minutes, about 55 minutes, or about 60 minutes. An image printed on a foamed topping composition is considered stable, if after the amount of time specified, at least 50% of a group of twenty untrained observers can identify the image.

For beverages where the image is printed directly on an ice-crystal matrix, the image printed on the ice-crystal matrix can remain stable indefinitely, provided the beverage is maintained at a sufficiently cold temperature and not jostled or otherwise disturbed. In more typical embodiments, however, such as for slush beverages that receive a printed image at the point of sale, and are subsequently provided to a consumer, the image can persist for about 2 to about 20 minutes after printing, subject to external factors including, but not limited to, temperature. In printed image can remain stable for about 2 minutes, about 3 minutes, about 4 minutes, about 5 minutes, about 6 minutes, about 7 minutes, about 8 minutes, about 9 minutes, about 10 minutes, about 5 minutes, or about 20 minutes. As above, an image printed on an ice-crystal matrix is considered stable, if after the amount of time specified, at least 50% of a group of twenty untrained observers can identify the image.

### EXAMPLES

The following examples are provided for the purpose of illustration only and the embodiments described herein should in no way be construed as being limited to these examples. Rather, the embodiments should be construed to encompass any and all variations which become evident as a result of the teaching provided herein.

Example 1

| Commercially available foamed topping composition sourced from PALSGAARD® | | |
|---|---|---|
| Ingredients | Wt % | Function |
| Hydrogenated palm kernel oil | 25% | Vegetable fat |
| Sodium caseinate | 0.8% | Protein |
| Sucrose | 10% | Sweetener |
| Sorbitol | 1% | Bulking agent |
| Carrageenan. | 0.6% | Stabilizer |
| Blend of polysorbate 80 and sodium stearolyl lactylate. | 1% | Emulsifier |

PEPSI® was added to a plastic cup and the commercially available foamed topping composition was applied to the topmost surface of the beverage to a thickness of 45 mm. The surface of the foamed topping composition was smoothed and leveled to a height that made the topmost surface of the foamed topping composition coplanar with the rim of the plastic cup holding the beverage. A photographic quality image of a celebrity with a resolution of about 600*600 dpi was printed on the topmost surface of the foamed topping composition using a beverage printer from Kopybake. The image printed on the beverage was stable and persisted on the foamed topping composition for 30 minutes before being discarded.

### Example 2

A bottle of MOUNTAIN DEW® was frozen for sufficient period of time to induce ice crystal formation. The partially frozen beverage was then transferred from the bottle into a plastic cup and a matrix of frozen ice-crystals formed on the surface of the slush beverage. A logo was printed on the ice-crystal matrix using the Kopybake beverage printer discussed in Example 1. The printed logo was stable and persisted on the ice-crystal matrix for at least 20 minutes.

### Example 3

PEPSI® was added to a plastic cup containing ice cubes and shaved ice was applied to the topmost surface of the beverage to a thickness of about 45 mm. The shaved ice was smoothed and leveled to a height that made the topmost surface of the shaved ice coplanar with the rim of the plastic cup holding the beverage. A photographic quality image of a celebrity with a resolution of about 600*600 dpi was printed on the topmost surface of the shaved ice using a beverage printer from Kopybake. The image printed on the beverage was stable and persisted on the shaved ice for 30 minutes before being discarded.

What is claimed is:

1. A beverage composition comprising:
a) a beverage;
b) a foamed topping composition in fluid communication with a topmost surface of the beverage, the foamed topping composition comprising a vegetable fat and water; and
c) a printed image on a topmost surface of the foamed topping composition; wherein the foamed topping composition is substantially free of dairy.

2. The beverage composition of claim 1, wherein the foamed topping composition further comprises:
a) an emulsifier;
b) a stabilizer;
c) optionally a protein;
d) optionally a sweetener; and
e) optionally a flavoring agent.

3. The beverage composition of claim 1, wherein the vegetable fat is partially or wholly hydrogenated vegetable oil, or a combination thereof.

4. The beverage composition of claim 2, wherein the emulsifier is selected from the group consisting of mono-, di-, or triglycerides of fatty acids, lactic acid esters of mono- and diglycerides, diacetyl tartaric acid esters of mono- and diglycerides, polyglycerol esters of fatty acid, sodium stearolyl lactylate, hexaglyceryl distearate, lecithin, hydroxylated lecithin, a polyoxyethylene ether of fatty esters of polyhydric alcohols, sucrose esters, and combinations thereof.

5. The beverage composition of claim 2, wherein the stabilizer is selected from the group consisting of microcrystalline cellulose, hydroxypropyl cellulose, hydroxypropyl methylcellulose, hydroxyethyl cellulose, carboxymethyl cellulose, starch, methylcellulose, ethylcellulose, carboxymethyl starch, hydrophobically modified starch, guar, pectin, pectinate, pectate, xanthan, carrageenan, agar, gellan, scleroglucan, betaglucan, alginate and alginic acid, propylene glycol-alginate, gum arabic, gum tragacanth, konjac gum, chitin, chitosan, locust bean gum, and combinations thereof.

6. The beverage composition of claim 2, wherein the protein is selected from the group consisting of whey, whey hydrolysate, whey concentrate, lactalbumin, β-lactoglobulin, bovine serum albumin, acid casein, casein, casein hydrolysate, caseinates, salts of caseinates, soy protein, rice protein, pea protein, wheat protein, corn protein, vegetable protein, wheat gluten, and combinations thereof.

7. The beverage composition of claim 2, wherein the foamed topping composition comprises:
a) about 25% vegetable fat;
b) about 0.6% stabilizer;
c) about 1% emulsifier;
d) about 0.8% sodium caseinate;
e) about 10% sucrose; and
f) about 1% sorbitol.

8. The beverage composition of claim 1, wherein the printed image comprises one or more edible inks.

9. A method of making the beverage composition of claim 1, the method comprising the steps of:
a) applying the foamed topping composition to the topmost surface of the beverage; and
b) printing an image on the topmost surface of the foamed topping composition.
wherein the foamed topping composition comprises a vegetable fat and water and
wherein the foamed topping composition is substantially free of dairy.

10. The method of claim 9, wherein the beverage is a carbonated beverage.

11. The method of claim 9, wherein the foamed topping further comprises:
a) an emulsifier;
b) a stabilizer;
c) optionally a protein;
d) optionally a sweetener; and
e) optionally a flavoring agent.

12. The method of claim 9, wherein the vegetable fat is partially or wholly hydrogenated vegetable oil or a combination thereof.

13. The method of claim 11, wherein the emulsifier is selected from the group consisting of mono-, di-, or triglycerides of fatty acids, lactic acid esters of mono- and diglycerides, diacetyl tartaric acid esters of mono- and diglycerides, polyglycerol esters of fatty acid, sodium stearolyl lactylate, hexaglyceryl distearate, lecithin, hydroxylated lecithin, a polyoxyethylene ether of fatty esters of polyhydric alcohols (i.e., a polysorbate, such as polysorbate 80), sucrose esters, and combinations thereof.

14. The method of claim 11, wherein the stabilizer is selected from the group consisting of microcrystalline cellulose, hydroxypropyl cellulose, hydroxypropyl methylcellulose, hydroxyethyl cellulose, carboxymethyl cellulose, starch, methylcellulose, ethylcellulose, carboxymethyl starch, hydrophobically modified starch, guar, pectin, pectinate, pectate, xanthan, carrageenan, agar, gellan, scleroglucan, betaglucan, alginate and alginic acid, propylene glycol-alginate, gum arabic, gum tragacanth, konjac gum, chitin, chitosan, locust bean gum, and combinations thereof.

15. The method of claim 11, wherein the protein is selected from the group consisting of whey, whey hydrolysate, whey concentrate, lactalbumin, β-lactoglobulin, bovine serum albumin, acid casein, casein, casein hydrolysate, caseinates, salts of caseinates, soy protein, rice protein, pea protein, wheat protein, corn protein, vegetable protein, wheat gluten, and combinations thereof.

16. The method of claim 11, wherein the foamed topping composition comprises:
a) about 25% vegetable fat;
b) about 0.6% stabilizer;
c) about 1% emulsifier;
d) about 0.8% sodium caseinate;
e) about 10% sucrose; and
f) about 1% sorbitol.

17. The method of claim 9, wherein the printed image comprises one or more edible inks.

18. A beverage composition comprising:
a) a slush beverage having a topmost surface comprising a frozen ice-crystal matrix;
b) a printed image on the topmost surface of the frozen ice-crystal matrix;.

19. The beverage composition of claim 18, wherein the slush beverage is carbonated or non-carbonated.

20. The beverage composition of claim 19, wherein the slush beverage is carbonated.

21. The beverage composition of claim 19, wherein the slush beverage is non-carbonated.

22. A method of making the beverage composition of claim 18, the method comprising printing an image on the topmost surface of the beverage using an inkjet printer with edible ink.

23. The method of claim 22, wherein the edible ink further comprises a flavor.

24. A beverage composition comprising:
a) a beverage; and
b) an edible substrate comprising one or more pre-printed images on a surface of the substrate;
wherein the edible substrate has a density sufficiently lower than the beverage such that at least one surface of the edible substrate is above a surface of the beverage and visible to someone drinking the beverage.

25. The beverage composition of claim 24, wherein the edible substrate is selected from the group consisting of a marshmallow, a cookie, a chocolate, a candy, a waffle, and a granola bar.

26. The beverage composition of claim 24, wherein the edible substrate is a circular ice disk or ice wafer.
